(19) United States
(12) Patent Application Publication
(10) Pub. No.: US 2025/0167383 A1
(43) Pub. Date: May 22, 2025

(54) BATTERY CELL

(71) Applicants: Volkswagen Aktiengesellschaft, Wolfsburg (DE); W. L. Gore & Associates GmbH, Putzbrunn (DE)

(72) Inventors: Tim DAGGER, Lingen (DE); Daniel KEGLMEIER, Putzbrunn (DE); Anton KILLER, Putzbrunn (DE); Paul MEISTER, Ilsede (DE); Piotr WRZUSZCZAK, Hannover (DE); Branislav ZLATKOV, Braunschweig (DE); Stefan BLASCZYK, Putzbrunn (DE); Joona RIIHIMAEKI, Putzbrunn (DE); Lisa WEISS, Braunschweig (DE)

(73) Assignee: W. L. Gore & Associates GmbH, Putzbrunn (DE)

(21) Appl. No.: 19/034,497

(22) Filed: Jan. 22, 2025

Related U.S. Application Data
(63) Continuation of application No. PCT/EP2023/070313, filed on Jul. 21, 2023.

(30) Foreign Application Priority Data
Jul. 22, 2022 (DE) 10 2022 207 532.3

(51) Int. Cl. H01M 50/342; H01M 50/30

(52) U.S. Cl. CPC H01M 50/3425; H01M 50/394; H01M 2220/20

(57) ABSTRACT

A battery cell having a cell housing, in which a plurality of electrodes is disposed. The cell housing comprises a wall having a pre-determined breaking region. The predetermined breaking region comprises an opening which is covered by a gas-permeable membrane. A recess extending to the opening is introduced into the wall in the predetermined breaking region.

This nonprovisional application is a continuation of International Application No. PCT/EP2023/070313, which was filed on Jul. 21, 2023, and which claims priority to German Patent Application No. 10 2022 207 532.3, which was filed in Germany on Jul. 22, 2022, and which are both herein incorporated by reference.

### BACKGROUND OF THE INVENTION

### Field of the Invention

The invention relates to a battery cell. The battery cell has a cell housing in which a plurality of electrodes is disposed.

### Description of the Background Art

Motor vehicles are increasingly being driven at least partially via an electric motor, so that they are designed as electric or hybrid vehicles. A high-voltage battery, which comprises a number of individual battery modules, is usually used to power the electric motor. The battery modules are usually structurally identical to one another and are electrically connected to one another in series and/or parallel, so that the electrical voltage applied to the high-voltage battery corresponds to a multiple of the electrical voltage provided by each of the battery modules. Each battery module in turn comprises a plurality of battery cells, which are usually disposed in a common module housing, and which are electrically connected to one another in series and/or parallel.

Each of the battery cells in turn usually comprises a plurality of galvanic elements. These each have two electrodes, namely, an anode and a cathode, as well as a separator disposed between them, and an electrolyte with freely mobile charge carriers. A liquid, for example, is used as such an electrolyte. In an alternative, the battery cell is configured as a solid-state battery and the electrolyte is present as a solid. The anode and the cathode, which form the electrodes of the battery cell, usually comprise a carrier which acts as a current collector. An active material is usually attached to this carrier, which is part of a layer applied to the carrier, which is also referred to as a conductor. In this case, it is possible that the electrolyte is already present in the layer, or that it is introduced later. At the very least, however, the active material is suitable for absorbing the working ions, e.g., lithium ions. Depending on whether it is used as an anode or a cathode, a different material is used for the carrier and a different type of material is used for the layer.

To protect the galvanic elements, they are usually disposed in a battery cell housing, also known as a cell cup. The electrolyte is also protected from environmental influences via the cell housing. So that a relatively large capacity is provided via the particular battery cell, a plurality of such galvanic elements, usually up to 100, are usually disposed in the common cell housing. In order to utilize the available space relatively efficiently and to simplify production, the individual components of the galvanic elements are designed to be flat and are stacked on top of one another in one direction, so that a cell stack with a substantially quadrangular shape is formed. For example, the separator can be made in the form of a strip and is provided on opposite sides with a plurality of electrodes. The strip is wound into a roll, in particular into a so-called “jelly roll.” Thus, the galvanic elements are rolled up into a cylindrical shape.

The cell housing is shaped depending on the arrangement of the galvanic elements used. Thus, it is possible to design it to be rigid and to be made of aluminum, for example. In this case, the shape of the cell housing is quadrangular, for example. Such a battery cell is also referred to as a prismatic cell. In an alternative design, the cell housing is created using a foil that is wrapped around the galvanic elements. Such a battery cell is also referred to as a pouch cell.

When the battery cell is in operation, therefore, when charging and discharging, it is possible that gases arise due to unwanted chemical reactions. Because of these, pressure within the cell housing increases, so that, one the one hand, a decontacting of individual electrodes can occur, which leads to a loss of power in the battery cell. On the other hand, it is possible that the cell housing is deformed due to the increased pressure, so that an environment of the battery cell in particular is mechanically affected. At a relatively high pressure, the cell housing bursts, so that the electrolyte can escape and the entire battery cell is no longer ready for use. It is also possible that unwanted chemical reactions of the individual components of the battery cell with the environment take place.

To avoid such gas formation, a special selection of the individual materials of the electrodes is required, which, on the one hand, increases production costs. On the other hand, the capacity of the battery cell is reduced with such materials. Alternatively, for example, additional elements are present in the cell housing via which the gases produced are bound and/or converted. In a further variant, the cell housing is designed to be relatively robust, so that the pressure that causes the cell housing to break is never reached during operation of the battery cell. However, due to the additional elements or the robust design of the cell housing, the installation space and also the weight of the battery cell are increased, which is why the energy density is reduced.

### SUMMARY OF THE INVENTION

It is therefore an object of the invention to provide a particularly suitable battery cell, whereby operational safety and/or energy density are advantageously increased and whereby production costs are expediently reduced.

In particular, the battery cell can be designed to be rechargeable and can be a secondary battery. In the intended state, the battery cell can be a component of a motor vehicle. The battery cell is suitable, in particular provided and configured for this purpose. In the intended state, the battery cell is, for example, a component of an energy storage device of the motor vehicle, which has a plurality of such battery cells. The battery cells are preferably divided among a number of battery modules, which in turn are structurally identical to one another. The battery cells are in particular arranged in a housing of the energy storage device or of the respective battery module and are electrically connected to one another in parallel and/or in series. The electrical voltage applied to the energy storage device/battery module is therefore a multiple of the electrical voltage provided by each of the battery cells. All battery cells are expediently structurally identical to one another, which simplifies production.

The housing of the energy storage device or of the respective battery module, which thus in particular form a group of such battery cells, can be made of a metal, for example, a steel, such as a stainless steel, or an aluminum alloy. For example, a die casting process, deep drawing process, squeeze casting, or extrusion is used for production. In particular, the housing of the energy storage device or the respective battery module is designed to be closed. An interface, which forms a terminal for the energy storage device/battery module, is expediently introduced into the housing of the energy storage device or of the respective battery module. The interface is electrically contacted with the battery cells, so that supplying of electrical power to and/or drawing of electrical power from the battery cells from outside the energy storage device are possible, provided that a corresponding connector is plugged into the terminal.

The motor vehicle can be land-based and can have a number of wheels, of which at least one, suitably a plurality thereof, or all of them, are driven via a drive. In particular, one, preferably a plurality of the wheels is designed to be controllable. It is thus possible to move the motor vehicle independently of a specific roadway, for example, rails or the like. It is expediently possible to position the motor vehicle essentially anywhere on a roadway, which is made in particular of asphalt, tar, or concrete. The motor vehicle is, for example, a commercial vehicle such as a truck or a bus. However, the motor vehicle is particularly preferably a passenger car. Alternatively, the motor vehicle is, for example, a boat, an airplane, a helicopter, a multicopter, a bicycle (pedelec), or a motorcycle.

Moving the motor vehicle occurs expediently via the drive. For example, the drive, in particular the main drive, is designed to be at least partially electrical, and the motor vehicle is, for example, an electric vehicle. The electric motor is operated, for example, via the energy storage device, which is suitably designed as a high-voltage battery. An electrical DC voltage is expediently provided via a high-voltage battery, whereby the electrical voltage is between 200 V and 800 V and is substantially 400 V, for example. An electrical converter, via which the power supply to the electric motor is set, is preferably disposed between the energy storage device and the electric motor. In an alternative, the drive additionally has an internal combustion engine, so that the motor vehicle is designed as a hybrid motor vehicle. In an alternative, a low-voltage vehicle electrical system of the motor vehicle is supplied with energy via the energy storage device, and in particular an electrical DC voltage of 12 V, 24 V, or 48 V is provided via the energy storage device.

The battery cell can be part of an industrial truck, an industrial plant, or a hand-held device, such as a tool, for example, in particular a cordless screwdriver. In a further alternative, the battery cell is part of an energy supply and is used there, for example, as a so-called buffer battery. In a further alternative, the battery cell is part of a portable device, for example, a portable cell phone or some other wearable. It is also possible to use such a battery cell in the camping sector, model-building sector, or for other outdoor activities.

The battery cell can have a plurality of electrodes, therefore, for example, two or preferably more. In particular, the electrodes are divided between anodes and cathodes, whereby half of the electrodes expediently form the anodes and the other half form the cathodes. However, there is preferably one more anode than cathode. Particularly preferably, all anodes and all cathodes are structurally identical to one another, which simplifies production. For example, the electrodes are designed to be flat and, in particular, have a carrier, which is also referred to as a conductor. In particular, the respective carrier is formed via a metal foil which is coated on one or both sides with a layer, at least in sections. For example, aluminum is used as the metal of the carrier/conductor of the cathodes and copper is used as the metal of the conductor of the anodes.

The layer here has a thickness of less than 1 mm. The carriers expediently have a thickness of less than 0.1 mm. The respective layer preferably has an active material, a binder, and/or a conductive additive, such as conductive carbon black. The active material is used to absorb working ions, such as lithium ions, and is suitable, as well as provided and designed for this purpose. For example, a lithium metal oxide such as lithium cobalt (III) oxide (LiCoO2), NMC, for example, NMC622 or NMC811, NCA, LMNO, or LFP, is used as the active material for the cathode and/or LTO or graphite, Si-based, for the cathode.

The electrodes can be essentially rectangular. The electrodes are, for example, stacked on top of each other to form a cell stack, whereby the stacking direction is perpendicular to the extension direction of the electrodes, which are arranged parallel to one another. In this case, the anodes and cathodes preferably alternate in the stacking direction of the cell stack. A separator of the cell stack is expediently arranged between neighboring electrodes, therefore in particular between one of the anodes and one of the cathodes, which separator is preferably also designed to be flat. For example, all separators are structurally identical. In particular, the electrodes are stacked substantially flush on top of one another, whereby, for example, the anodes protrude at least slightly over the cathodes. It is particularly preferred here if the protrusion is increased on one of the sides. Preferably, the cathodes likewise also protrude beyond the anodes on one side, whereby the (enlarged) protrusions are located on opposite sides of the cell stack. Contacting of the anodes and cathodes to other components is simplified in this way. Due to the stacking of the electrodes, the cell stack is thus also essentially quadrangular.

In an example, for example, all anodes, all cathodes, or the separator are formed via a common strip, or they are attached to a common strip. The strip itself can be rolled up into a cylindrical shape or the like, so that a so-called “jelly roll” is formed.

The battery cell can have a cell housing within which the electrodes are disposed, therefore, for example, the cell stack or the “jelly roll.” The cell housing suitably has a base body within which the electrodes are arranged. The base body is made, for example, pot-shaped and closed via a cell housing cover. The arrangement of the electrodes is thus simplified. In particular, a volume between 0.1 dm3 and 10 dm3 is surrounded via the cell housing, preferably the base body. For example, the cell housing is additionally at least partially filled with an electrolyte, or the electrolyte is already partially formed via the respective active material, for example. The cell housing, in particular the possible base body, is preferably designed to be rigid. In other words, the battery cell is a prismatic cell. In particular, the cell housing, preferably the base body and/or the possible cover, are made of a metal such as aluminum, therefore, pure aluminum or an aluminum alloy. The cell housing, in particular the base body, has, for example, a quadrangular shape. The cell housing, and preferably the base body, can be designed to be flexible and, for example, at least partially formed via a metal foil, which is coated on one or both sides in particular. The electrodes are wrapped by the metal foil and the ends of the metal foil are expediently sealed, so that escape of the electrolyte and/or entry of ambient air into the cell housing are prevented.

The electrodes can be disposed directly in the cell housing, so that the electrodes are in contact with an inner wall of the cell housing, for example, directly or via another component, and are thus stabilized by it. At the very least, the cell housing serves directly to protect the electrodes and/or to prevent contact of the electrodes/electrolytes with ambient air or other particles. In other words, the electrodes within the cell housing are preferably not, at least not completely, surrounded by another component, so that the weight of the battery cell and material costs are reduced. In particular, no further housing is present in the cell housing via which the electrodes are surrounded. Consequently, it is possible to essentially fill the cell housing completely with the electrodes and the possible separator(s).

The cell housing can have at least one or two apertures through each of which a terminal is guided. At least some of the electrodes disposed in the cell housing are electrically contacted via the terminal(s), so that it is possible via the terminal(s) to supply electrical energy and/or to draw it from outside the cell housing to or from the galvanic elements formed via the electrodes. If there is only a single terminal, at least some of the electrodes are electrically contacted with the cell housing, so that an electrical potential of the cell housing is predetermined via these electrodes. In particular, the terminal or terminals are electrically insulated from the cell housing, whereby the terminals are connected to the cell housing in a fluid-tight manner, so that electrolyte leakage in the area of the terminals is prevented.

The cell housing, in particular the possible base body, can have a wall with a predetermined breaking region. In other words, the wall has the predetermined breaking region. In this case, the wall is made, for example, flat or curved/uneven. The predetermined breaking region thus covers a certain area of the cell housing, in particular of the base body, namely, a part of the wall. The predetermined breaking region is designed in such a way that it breaks at a certain pressure difference between the inside and the outside of the cell housing, so that in particular mass transfer between the inside of the cell housing and the environment is made possible. The breaking of the predetermined breaking region is irreversible hereby. For example, if the pressure difference is exceeded, which is also referred to below in particular as burst pressure, the predetermined breaking region breaks completely or only partially. In particular, in this case, the area of the predetermined breaking region that breaks and is thus opened depends on the actually present pressure difference.

In particular, the cell housing can be designed in such a way that when the burst pressure is exceeded, the cell housing initially only breaks in the area of the predetermined breaking region, therefore, part of the wall, whereas the remaining components of the cell housing, in particular the base body, remain intact. These are only damaged if the pressure difference is increased further and, in this case, break in particular in an uncontrolled manner. The burst pressure is preferably selected such that it is lower than the pressure difference between a pressure inside the cell housing and a pressure outside the cell housing, which leads to the (uncontrolled) destruction of the cell housing, for example, a complete bursting or breaking. The burst pressure is preferably between 70% and 90%, between 75% and 85%, or 80% of this pressure difference.

The predetermined breaking region can have an opening which is located in particular in a central area, therefore, offset inwards from an edge of the predetermined breaking region. The distance between the opening and an edge of the predetermined breaking region is suitably greater than a fourth of the extent of the predetermined breaking region in the respective direction. In particular, the opening is located exactly in the center of the predetermined breaking region. The area of the opening is smaller than the area of the predetermined breaking region and in particular smaller than 50%, 20%, 10%, 5%, 1%, or 0.1% thereof.

The opening can be covered by a membrane that is gas permeable. In particular, the membrane can be rigidly, therefore, immovably, attached to the cell housing, preferably to the base body and/or to the predetermined breaking region, so that movement of the membrane with respect to the cell housing/base body is averted. The area of the membrane is at least equal to the area of the opening or preferably larger, so that the membrane completely overlaps the opening. The membrane is preferably arranged in such a way that the passage of liquids and/or gas between the membrane and the predetermined breaking region is prevented. In other words, the membrane is attached to the cell housing in a gas- and fluid-tight manner, for example, directly or via other components. Particularly preferably, therefore, the membrane is suitably welded to the cell housing, e.g., to the predetermined breaking region, with a circumferential weld seam. For example, an ultrasonic, laser, or temperature welding process is used for this. Alternatively, for example, the membrane is connected to the cell housing, in particular glued, in a form-fitting and/or bonding manner. In this case, the opening is expediently completely surrounded via the adhesive or the weld. For example, the connection is made directly adjacent to the opening, or there is a gap between the opening and the connection of the membrane to the cell housing, for example, to the adhesive or the weld. Consequently, escape of the gas from or into the cell housing is only possible through the opening, whereby the gas is also passed through the membrane.

In particular, the membrane can be selected such that it is permeable to CO, CO2, H2, and/or CH4. For example, passage of such gases is not impeded or is impeded only to a relatively small extent by the membrane. However, the permeability of the membrane to moisture, in particular to water vapor, is preferably significantly lower. In particular, the membrane has a ratio of CO2 permeability to moisture permeability of at least 0.5, at least 1, or at least 1.5. Preferably, the ratio is more than 0.5 and less than 3. In particular, the membrane acts as a barrier to the penetration of moisture, in particular water vapor, into the cell housing. In summary, the membrane is designed in such a way that these gases produced in the cell housing can pass through the opening out of the cell housing, which is what the opening is used for. In this case, entry of moisture and liquids, especially water, into the cell housing is made more difficult or significantly reduced via the membrane.

The membrane can be made of a polymer and can be, for example, a film, for example, a polymer film. The membrane is made of or consists of PTFE, therefore, a polytetrafluoroethylene. The membrane expediently has a crystallinity between 85% and 100% and a density between 0.2 g/cm3 and 2 g/cm³. With such a choice of material, gas permeability is ensured, whereby the penetration of moisture, in particular water vapor, into the cell housing is prevented or at least hampered by the membrane. A membrane suitable for battery applications is described in WO 2021/079163 A1. For example, the membrane is designed to be flat. Production is simplified and weight is reduced in this way.

A recess, which is therefore located in the predetermined breaking region, can be made in the wall that has the predetermined breaking region. In particular, the recess is only located here in the predetermined breaking region. A reduction of the wall thickness of the wall, therefore, the thickness of the wall, occurs via the recess, whereby the recess is only local. The recess preferably extends along a section that is, for example, corrugated/curved in a straight line or shaped in some other way. The recess is preferably elongated. For example, the recess is a notch and in particular has a V-shaped cross section. Alternatively, the recess is shaped like a channel or groove. The recess extends as far as the opening, so that at least a section of the edge of the opening merges into the recess and/or has a part thereof.

Due to the gas-permeable membrane, continuous degassing of the cell housing is essentially possible, so that the formation of a pressure difference between a pressure outside the cell housing and a pressure inside the cell housing, in particular due to the unwanted formation of gases in the cell housing during operation of the battery cell, is averted or slowed down. Due to the relatively small area of the opening, on the one hand, the mechanical integrity of the cell housing is only insignificantly reduced. On the other hand, penetration of foreign substances, such as moisture or liquids, into the cell housing is possible in principle only in this area, which is relatively unlikely. Thus a relatively safe operation of the battery cell over a relatively long period of time is possible, so that operational safety is increased. In other words, during undisturbed operation of the battery cell, there is no excessive accumulation of gases within the cell housing due to the essentially continuous discharge via the membrane, so that the pressure difference between the environment of the cell housing and the interior of the cell housing remains relatively low.

However, if, due to unwanted chemical reactions in the cell housing, for example, in the event of an overload, the pressure difference increases relatively strongly and quickly, so that the gases produced cannot be adequately discharged via the opening and the membrane, the predetermined breaking region breaks and the cell housing is opened at a defined point, namely, in the predetermined breaking region. Consequently, uncontrolled damage to the cell housing and an uncontrolled influence on the environment are averted. In fact, this only takes place in the area of the predetermined breaking region, and it is therefore possible to adapt the installation situation of the battery cell to this. This increases operational safety.

The breaking/tearing starts in the area of the recess, which represents a mechanical weakening of the wall. Because the recess extends to the opening, the initial force required for this is reduced. Thus, it is ensured by the recess extending to the opening that, on the one hand, tearing of the predetermined breaking region actually and always occurs when the burst pressure is exceeded, which increases safety. On the other hand, due to the recess extending to the opening, the tearing/breaking starts at the opening and runs along the recess. The shape of the tear is therefore also predetermined. If the burst pressure was only slightly exceeded, the predetermined breaking region does not tear open completely, but only partially along the recess, so that operation of the battery cell is also possible further if necessary.

For example, the predetermined breaking region can have a reduced wall thickness compared to the rest of the wall, whereby the wall thickness, therefore, the thickness of the wall, is further reduced in the area of the recess,. It is thus ensured that if the burst pressure is exceeded, the wall only tears in the area of the predetermined breaking region. Alternatively, the predetermined breaking region has essentially the same wall thickness as the rest of the wall, with the exception of any recess or other local reductions in the wall thickness. Production is made easier in this way. No damage also occurs in the event of mechanical stress during assembly, which is why robustness is increased.

The predetermined breaking region can be made in one piece with the rest of the wall, and can be initially formed with it. In other words, the predetermined breaking region is not formed via an initially separate component that was inserted into a corresponding recess in the wall. Fabrication is thus made easier. For example, the recess is already present when the wall is first formed or is preferably made subsequently, for example, by etching, lasering, or engraving. Production of the battery cells is made easier in this way. To produce the battery cell, the cell housing having the (undamaged) wall is created first in particular, for which reason an extrusion process is used, for example. The opening and the recess are then made in the wall, which are therefore not created by the primary forming of the wall. The opening is then covered with the membrane, which is preferably attached to the cell housing.

For example, the membrane can be attached to an outer side of the cell housing/wall, for example, to an outer side of the predetermined breaking region or of the possible base body. In this way, an interior space of the cell housing is not filled via the membrane, so that a relatively large volume is available there for the electrodes. Thus, the capacity of the battery cell is increased. It is also possible in this way to select an area of the membrane that is larger than the area of the opening. After the gases have passed through the opening, an increased surface area is thus available for them to pass through the membrane.

The membrane can be disposed on an inward-facing side of the predetermined breaking region. In other words, the membrane can be offset into the interior of the cell housing with respect to the predetermined breaking region. In this way, even at a relatively high pressure within the cell housing, the membrane is not excessively bulged outwards if due to the design of the membrane, no immediate passage of gases is enabled. In this case, the membrane is at least partially pressed against the inward-facing side of the predetermined breaking region. Consequently, the membrane is stabilized via the predetermined breaking region, which increases robustness. Passage of gas between the predetermined breaking region and the membrane is also prevented, which increases the sealing in this area.

The opening can be covered by a gas-permeable, hydrophobic, therefore, at least water-repellent, further membrane. The contact angle of the material of the further membrane to water is preferably greater than 80°, 90°, or 100°, in particular if the material is also exposed to air or is located in ambient air. Moisture is thus kept away from the membrane by the further membrane, which is why the entry of moisture into the cell housing is further impeded. At the very least, however, the further membrane prevents moisture from penetrating from the outside.

For example, the predetermined breaking region/opening can be positioned anywhere on the cell housing. However, particularly preferably, when the battery cell is designed as a pouch cell, it is located in the area of one of the ends of the cylindrical shape, near the conductor, in which the possible foil is particularly sealed (e.g., on the so-called gas pocket). In this case, the predetermined breaking region/opening is expediently offset inwards from the respective end(s) up to a maximum of one third of the maximum length of the cell housing.

If the battery cell is a prismatic cell, the predetermined breaking region/opening can be located in the area of the front and/or narrow sides, which are particularly not parallel to the electrodes layered to form the possible cell stack. As an alternative, the opening is located in one of the sides of the cell housing that is parallel to the electrodes, but preferably in an edge area, therefore, offset inward from the edge to a maximum of one-third of the width of the side. Due to such a position of the opening, construction is simplified and it is not necessary to change an existing design draft of the cell stack. Furthermore, the predetermined breaking region/opening is thus disposed in an area where the arising gases collect, so that a relatively efficient removal of the gases through the opening is made possible.

The predetermined breaking region can be made, for example, stadium-shaped, round, or rectangular. In particular, an area of the predetermined breaking region is between 0.01 cm2 and 20 cm2 and preferably between 0.1 cm2 and 10 cm2. The predetermined breaking region suitably has a size between 0.01% and 50% of the area of the cell housing. The predetermined breaking region preferably has a size between 0.1% and 40%, and in particular between 0.3% and 30%, of the area of the entire cell housing. For example, the membrane has an area that is 50% greater than the opening. The opening suitably has an area from 50 μm2 to 15 mm2, preferably from 0.2 mm2 to 3 mm2.

The predetermined breaking region can be limited via a further recess. In other words, the edge of the predetermined breaking region is at least partly formed via the further recess, and at the edge of the predetermined breaking region the wall thickness is thus locally reduced due to the further recess. The wall is thus also weakened structurally via the further recess, so that if the burst pressure is exceeded, tearing also occurs along the further recess, which is why the predetermined breaking region is thus also opened at the edge.

For example, only part of the edge of the predetermined breaking region may be formed via the further recess. If the wall thus tears along the further recess when the burst pressure is exceeded, tearing does not occur along the part of the edge of the predetermined breaking region, which part does not have the further recess. Consequently, even when the further recess is completely torn, the components of the predetermined breaking region remain on the wall and are bent outwards, so that a type of film hinge is formed. An uncontrolled movement away of the individual fragments of the wall is thus averted, which prevents damage to the surrounding components. As an alternative, the further recess is circumferential, so that the entire predetermined breaking region is enclosed via the further recess. Thus, when the burst pressure is exceeded and the entire further recess tears, the entire predetermined breaking region is detached from the rest of the wall, which is why a relatively fast pressure equalization can take place. Thus, further uncontrolled destruction of the cell housing is averted, which is why operational safety is increased.

For example, the recess can be spaced from the further recess. However, the recess especially preferably extends to the further recess. In other words, the two recesses merge into one another. Consequently, when the burst pressure is exceeded, the recess begins to tear at the opening, and the tearing is directed to the further recess, which thus also tears subsequently. In summary, the tearing of the predetermined breaking region starts at the opening, and runs along the recess to the further recess and then along the further recess. Thus, the force required for the initial tearing of the further recess is reduced. Consequently, it is ensured that the predetermined breaking region tears at least partially on the circumference, so that a relatively large part of the wall is released. A relatively fast pressure equalization is thus realized.

For example, an angle between the recess and the further recess is arbitrary or, for example, 90°. However, particularly preferably, the angle between the recess and the further recess is greater than 110° as in the area of the transition. The angle is expediently greater than 140° or 170°. The intersection of the recess with the further recess forms the apex of the angle. It is ensured in this way that the tearing of the recess is also transferred to the further recess, and the force required to start tearing the further recess is reduced. For example, the recess and/or the further recess are linear in the area where they meet. However, the transition between them is particularly preferably curved. In this way, the force required to start the tearing of the further recess is further reduced, which is why the tearing is reliably continued as soon as it has begun.

For example, the predetermined breaking region may have only the recess and possibly the further recess. However, particularly preferably, an additional recess extending to the opening is made in the wall in the predetermined breaking region. The additional recess thus also provides a local reduction in wall thickness. Thus, if the burst pressure is exceeded, the predetermined breaking region is also opened along the additional recess, so that a large part of the predetermined breaking region is released relatively quickly, so that rapid pressure equalization is enabled. The additional recess is preferably located on the opposite side of the opening with respect to the recess. In particular, an angle between the recess and the additional recess is greater than 160° or 170°, whereby the opening forms the apex of the angle. The angle is preferably equal to 180°. The recess and the additional recess are suitably configured in an S-shape and, for example, are point-symmetrical with respect to one another relative to the opening. Thus, when the burst pressure is exceeded, a relatively large area is quickly released.

Preferably, the additional recess can also extend to the further recess, if this is present. Thus, the tearing of the further recess begins at two different points, namely, in the area of the intersection with the recess and in the area of the intersection with the additional recess, which is why the area released within a certain time due to the tearing/breaking is further enlarged. For example, only the recess and the additional recess are present, which extend to the opening. Particularly preferably, there are other such additional recesses that also extend to the opening, which is why the area released within a certain period of time after the burst pressure is exceeded is further increased.

For example, the cell housing may only have the single opening that is covered by the membrane. Alternatively, the cell housing comprises a number of such openings, each of which is covered by the membrane. In this case, the membrane is made continuous, for example, or a corresponding (separate) membrane is assigned to each opening. Particularly preferably, these are introduced into the same wall.

To summarize, the battery cell thus can have a second opening in addition to the opening and possibly other such openings. For example, the second opening is located outside the predetermined breaking region. Particularly preferably, however, the second opening is a component of the predetermined breaking region, and the second opening is arranged in particular symmetrically with respect to the opening. The second opening is covered either by the membrane or by another second membrane, so that the passage of gas is also enabled here, but entry of moisture into the cell housing is averted. For example, the edge surrounding the second opening is intact. In other words, the area around the second opening has a constant wall thickness.

Particularly preferably, however, a second recess extending to the second opening can be made in the wall in the predetermined breaking region. For example, the second opening and/or the second recess are structurally identical to the opening or to the recess, respectively. Alternatively, they differ, for example, in their dimensions, so that a different optimization can occur. Due to the second opening and the second recess, the predetermined breaking region also tears there when the burst pressure is exceeded. Thus, the area released within a certain period of time after the burst pressure is exceeded is further increased, whereby, however, there still is no excessive structural weakening of the cell housing or is penetration of foreign particles into the battery cell possible during normal operation. Production costs are also not or only slightly increased, and the second opening and the second recess are made in the wall particularly in the same work step as the opening and the recess.

For example, there is an additional second recess extending to the second opening, so that the tearing also takes place in different directions starting from the second opening. If the additional recess is present, the second recess in particular extends to the additional recess, which is why the tearing is directed to the additional recess via the second recess.

For example, the area of the wall between the two openings is undamaged. Particularly preferably, however, the two openings are connected via a connecting recess. In other words, the connecting recess is made in the wall, therefore, also a local reduction in the wall thickness, whereby the connecting recess runs between the two openings, therefore, extends as far as the two openings. Consequently, even if the burst pressure is exceeded, the area between the two openings is torn via the connecting recess, whereby the tearing begins in particular from both openings. Thus, the speed at which a certain area is released after the burst pressure is exceeded is increased further. For example, the connecting recess is linear or, particularly preferably, corrugated or curved. Thus, the length of the connection recess is increased, which is why an area for the passage of gas is increased after the burst pressure is exceeded, so that a relatively quick pressure equalization can take place. A number of such second openings and corresponding second recesses are present particularly preferably.

In particular, the size of the membrane can be smaller than the size of the (entire) predetermined breaking region. In other words, the predetermined breaking region completely covers the membrane. Material costs are reduced in this way. The membrane area can also be optimized with regard to the necessary size and its connection to the predetermined breaking region/cell housing, regardless of the size of the predetermined breaking region. In addition, after tearing of the recess and opening of the predetermined breaking region, at least part of the area covered by the predetermined breaking region is not covered by the membrane, which is why a relatively unhindered pressure equalization can take place there. Alternatively, the size of the membrane is greater than the size of the predetermined breaking region, and the membrane overlaps the predetermined breaking region. In this way, if the membrane is attached to the cell housing, particularly at the edge, the predetermined breaking region is not affected.

For example, the predetermined breaking region may include further auxiliary recesses that are spaced apart from the opening or other openings. The auxiliary recesses extend, for example, to another of the existing recesses or are also spaced apart from them. A shape of the tearing in particular is predetermined via the auxiliary recesses, which represent a structural weakening of the predetermined breaking region, so that the predetermined breaking region is opened in a desired manner. For example, the recesses of the predetermined breaking region differ from one another. However, particularly preferably, they have essentially the same depth, which is why fabrication is made easier. Also if the burst pressure is exceeded, the recesses are torn in an undifferentiated manner, so that the rest of the construction is not affected if one of the recesses malfunctions, for example. Alternatively or in combination with this, the cross section of the recesses is the same in relation to each other, so that they can be produced with the same tool. In a further alternative, at least one of the recesses has a different depth. It is thus possible to predetermine the sequence of tearing of the predetermined breaking region and to adapt it, for example, to the components surrounding the battery cell in the assembled state.

The invention also relates to an assembly of such battery cells, whereby the assembly can be a battery module or a high-voltage battery. The invention relates further to a motor vehicle, such as a passenger car, with such a battery cell, in particular such an assembly. The battery cell is used in particular to supply power to a main drive of the motor vehicle.

The advantages and refinements described in connection with the battery cell can also be applied analogously to the assembly/vehicle and to one another and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows in a schematically simplified a motor vehicle, which has plurality of structurally identical battery cells;

FIG. 2 schematically shows in a sectional view one of the battery cells having a cell housing with a predetermined breaking region;

FIG. 3 shows the predetermined breaking region schematically in a plan view;

FIG. 4 schematically shows the predetermined breaking region in a sectional view; and

FIGS. 5-12 each show variants of the predetermined breaking region schematically in a plan view.

### DETAILED DESCRIPTION

Parts corresponding to one another are provided with the same reference characters in all figures.

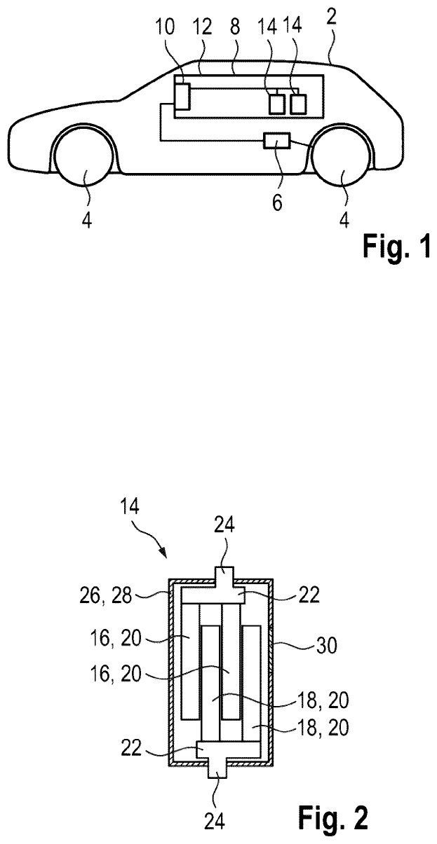

In FIG. 1, a motor vehicle 2 in the form of a passenger car is shown in a schematically simplified manner. Motor vehicle 2 has a number of wheels 4, at least some of which are driven via a drive 6 which comprises an electric motor. Thus, motor vehicle 2 is an electric vehicle or a hybrid vehicle. Drive 6 has a converter via which the electric motor is powered. The converter of drive 6 is powered in turn by an energy storage device 8 in the form of a high-voltage battery. For this purpose, drive 6 is connected to an interface 10 of energy storage device 8, which interface is introduced into an energy storage housing 12 of energy storage device 8, the housing being made of stainless steel.

A plurality of battery modules, which are not shown in detail and are structurally identical to one another, are disposed within energy storage housing 12 of energy storage device 8, each module comprising multiple battery cells 14. Battery cells 14 of each battery module are partly electrically connected to one another in series and partly electrically connected to one another in parallel. Some of the battery modules are in turn electrically connected to one another in series and these are in turn electrically connected to one another in parallel. The electrical assembly of the battery modules is in electrical contact with interface 10, so that discharging or charging (recuperation) of the battery modules and thus also battery cells 14 occurs when drive 6 is in operation. Because of the electrical interconnection, in this case, the electrical voltage provided at interface 10, which is 400 V, is a multiple of the electrical voltage provided with each of the battery modules and also with each of battery cells 14.

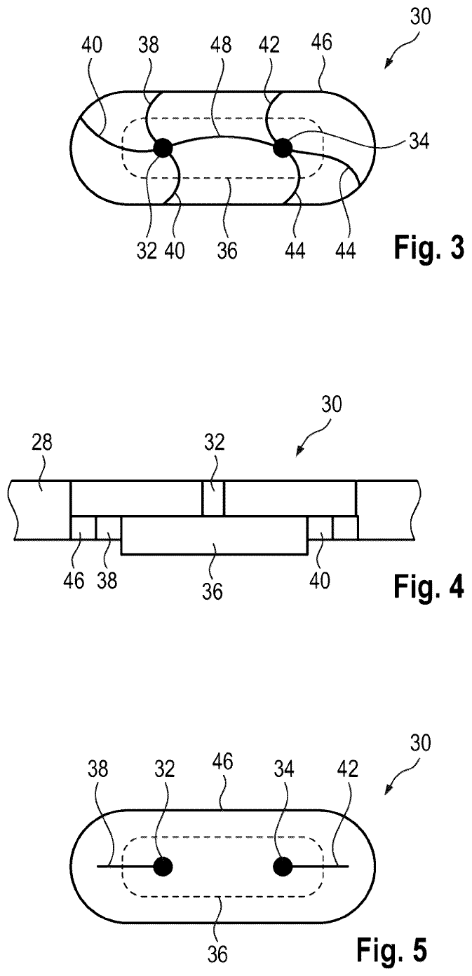

In FIG. 2, one of battery cells 14, which are structurally identical to one another, is shown in a sectional view. Battery cell 14 has a plurality of anodes 16 and cathodes 18, of which only two are shown in each case. Anodes 16 and cathodes 18, which form electrodes 20 of battery cell 14, each have a flat design and are stacked alternately on top of one another to form a cell stack, whereby a separator can be disposed between adjacent anodes 16 and cathodes 18. Anodes 16 protrude over cathodes 18 on a common side, namely, in each case comprising a respective conductor, which is formed via a respective metal foil. In the area of the protrusion, moreover, the respective conductor is free of further components, but in the other areas a layer comprising an active material is applied to the respective conductor, which is also referred to as a carrier. Cathodes 18 also protrude over anodes 16 in the same way, whereby the protrusions are located on opposite sides of the stack formed by anode 16 and cathodes 18.

The protrusions of anodes 16 and cathodes 18 are each welded to an associated busbar 22, which is made of copper. One of busbars 22 is assigned hereby to each of anodes 16 and cathodes 18. Busbars 22 each have a terminal 24, which is passed through a quadrangular cell housing 26, within which anodes 16 and cathodes 18 are disposed. Cell housing 26 is rigid and made of aluminum. Thus, battery cell 14 is a prismatic cell. Cell housing 26 is filled with a liquid electrolyte.

Cell housing 26 has a wall 28 with a predetermined breaking region 30, which has an area of 5 cm2. Predetermined breaking region 30 is constructed in such a way that when there is a pressure difference between a pressure outside cell housing 26 and a pressure inside cell housing 26 that exceeds a burst pressure of 1 bar, the predetermined breaking region breaks, so that cell housing 26 opens and pressure equalization can take place. The burst pressure is 90% of the maximum pressure load of cell housing 26, therefore, the pressure difference at which an irreversible and uncontrolled destruction of cell housing 26 occurs.

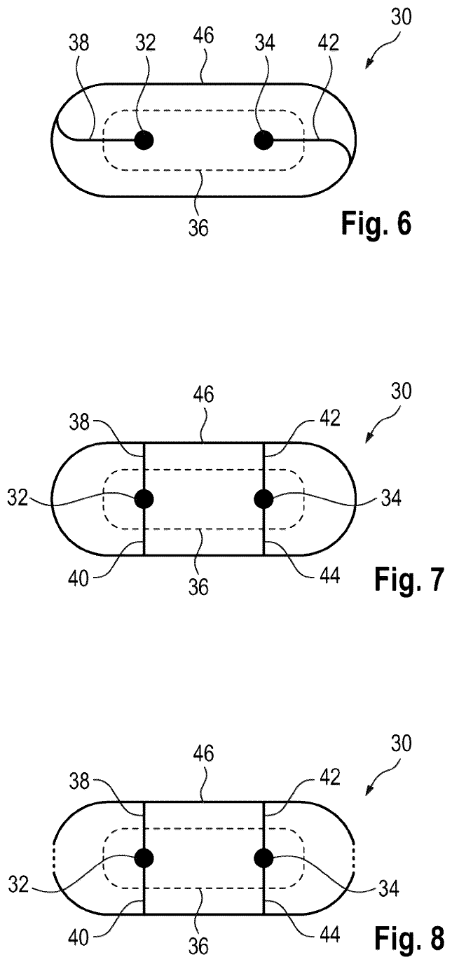

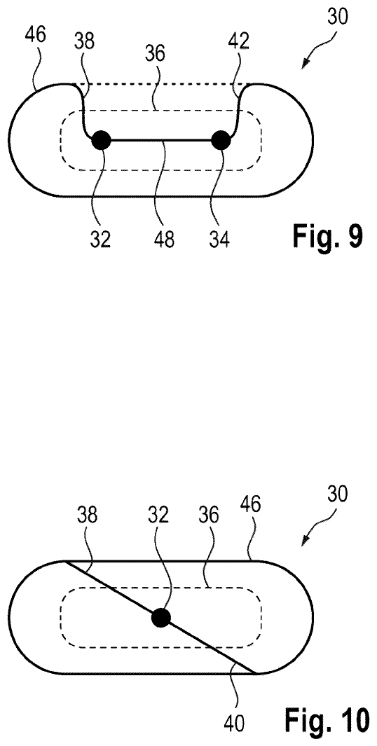

In FIG. 3, predetermined breaking region 30 is shown schematically in a plan view and in FIG. 4 in a sectional view. Predetermined breaking region 30, which is integral with the rest of wall 28, is stadium-shaped and has an opening 32 and a second opening 34, each of which passes through the complete predetermined breaking region 30, therefore, wall 28. On the inner side, opening 32 and second opening 34 are covered via a gas-permeable membrane 36, which is attached to the inner side of wall 28, namely, the inner side of predetermined breaking region 30, for example, via welding. In this case, the size of membrane 36 is smaller than the size of predetermined breaking region 30, but the passing of particles from the interior of cell housing 26 to the outside and vice versa is possible only through membrane 36. Membrane 36 is made of PTFE, so that entry of moisture into the interior of cell housing 26 is prevented by it. However, escape of CH4, for example, from cell housing 26 through membrane 36 as well as through opening 32 and second opening 34 is possible.

A recess 38 extending to opening 32 is introduced into predetermined breaking region 30, namely, into the inner side of wall 28. Recess 38 has a corrugated/curved shape and extends to opening 32, whereby recess 38 is partially covered via membrane 36 and whereby membrane 36 partially fills recess 38. Recess 38 is a local reduction in the wall thickness of wall 28 in predetermined breaking region 30, whereby a cross section of recess 38 is rectangular in the example shown.

In addition, two additional recesses 40 extending to opening 32 are made in wall 28 in predetermined breaking region 30, whereby these also have a corrugated or curved shape. The depth of additional recesses 40 corresponds to the depth of recess 38, and they are also designed in the same way in other respects. In this case, one of additional recesses 40 is arranged point-symmetrically to recess 38 with respect to opening 32. Thus, recess 38 and this additional recess 40 meet at an angle of 180° at opening 32. The remaining additional recess 40 is rotationally symmetric with respect to recess 38 or the other additional recess 40 with respect to the opening by an angle of 90°.

A second recess 42 extending to second opening 34 is also formed in wall 28 in predetermined breaking region 30; the second recess is essentially structurally identical to recess 38, but is offset with respect to second opening 34. In other words, the course of second recess 42 is the same as the course of recess 38. Furthermore, two additional second recesses 44 are associated with second opening 34; these are formed in wall 28 in predetermined breaking region 30 and extend to second opening 34. One of the additional second recesses 44 is point-symmetrical to second recess 42 with respect to second opening 34, and the remaining additional second recess 44 is rotationally symmetric by an angle of 90° to second recess 42 and the other additional second recess 44 with respect to second opening 34. Recess 38, additional recesses 40, second recess 42, and additional second recesses 44 always have the same cross section as well as the same length and the same course, whereby only the orientation and/or assignment to respective opening 32, 34 is different.

Predetermined breaking region 30 is limited via a circumferential further recess 46, which thus forms the edge of predetermined breaking region 30. Consequently, the course of the further recess 46 is stadium-shaped, whereby the cross section of further recess 46 corresponds to the cross section of recess 38. Recess 38, additional recesses 40, second recess 42, and the additional second recesses 44 extend as far as the further recess 46 and merge into it. In this case, due to the curved course of recess 38, additional recesses 40, second recess 42, and additional second recesses 44, the angle formed between these and further recess 46 is greater than 110° at the point of intersection, whereby there is a substantially continuous transition.

Furthermore, a connecting recess 48 is formed in the inner side of wall 28, which recess extends to opening 32 as well as to second opening 34. In other words, the two openings 32, 34 are connected via connecting recess 48. The depth and the cross section of connecting recess 48 correspond to the respective value of recess 38. The course of connecting recess 48 is corrugated, and it meets one of the additional recesses 40 at opening 32 at an angle of 180°, and one of the additional second recesses 44 at second opening 34, also at an angle of 180°.

During operation of battery cell 14, it is possible that gases are produced in cell housing 26 due to undesired chemical reactions. These can escape from cell housing 26 to the outside via membrane 36 and the two openings 32, 34, so that there is no excessive increase in pressure. In the event of a malfunction or excessive load, it is possible that the speed of the gas discharge is not sufficient to limit the pressure increase inside cell housing 26. If the pressure difference between the inside of cell housing 26 and the outside exceeds a limit value, namely, a burst pressure, predetermined breaking region 30 begins to tear open starting from opening 32 along recess 38 and the additional recess 40 as well as along connecting recess 48. Starting from second opening 34, predetermined breaking region 30 also begins to tear along second recess 42, the additional second recess 44, and connecting recess 48. Due to the local reduction in the wall thickness, the force required to start tearing is reduced, so that tearing always starts when the burst pressure is exceeded. As a result of the tearing, an area for the gas to escape is increased, so that the pressure increase is limited. As soon as the pressure does not increase further, the tearing stops and predetermined breaking region 30 remains partially open.

However, if there is a relatively serious malfunction and the pressure difference continues to rise, the tearing continues. The tearing continues until the entire recess 38, the additional recesses 40, connecting recess 48, second recess 42, and the additional second recesses 44 are completely torn open. From these, the tearing continues to further recess 46, which thus also begins to tear, namely, at six different points. Due to the transition of the individual recesses 38, 40, 42, 44 to further recess 46, further recess 46 tears clockwise from the points in the example shown. When further recess 46 is completely torn, the individual components of predetermined breaking region 30 are separated from the rest of the wall 28 and are detached from cell housing 26 due to the excess pressure in it. Thus, there is a relatively large area for pressure equalization, so that at least then the pressure increase is stopped. It is prevented in this way that cell housing 26 bursts in an uncontrolled manner. Consequently, other components of motor vehicle 2 located in the vicinity of battery cell 14 are not destroyed, even if battery cell 14 is no longer ready for use.

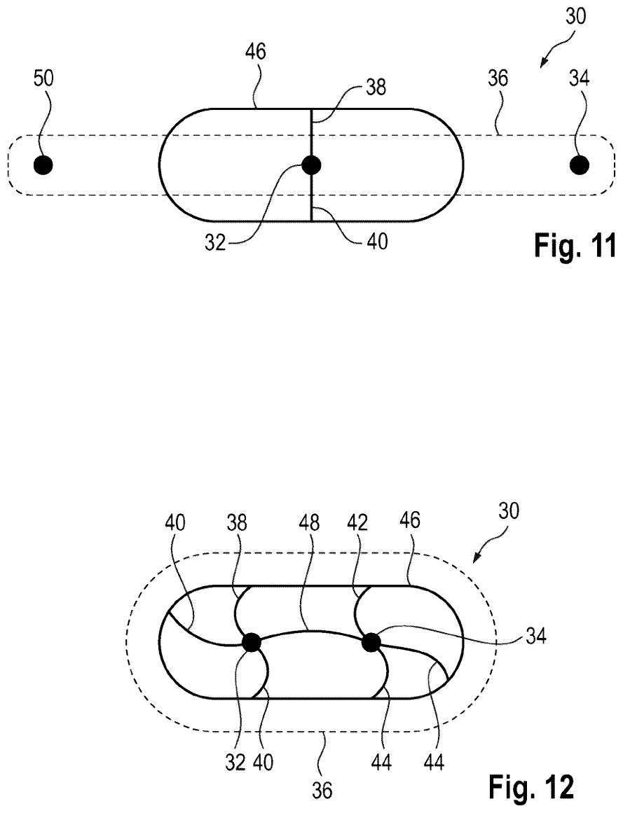

FIGS. 5-11 show different examples of predetermined breaking region 30 as shown in FIG. 3, but these are always stadium-shaped. The respective predetermined breaking region 30 is also limited in each case by further recess 46. In the variant shown in FIG. 5, membrane 36 and the two openings 32, 34 have not been modified. Connecting recess 48, additional recesses 40, and additional second recesses 44 are not present. Recess 38 and second recess 42, which extend to the respective openings 32, 34, are present. However, these are now designed in a straight line and point away from the respective other opening 32, 34 in the direction of further recess 46. In this case, recess 38 and second recess 42 are spaced apart from further recess 46. In this example, the area initially released by the tearing of the two recesses 38, 42 is limited, so that operation of battery cell 14 is still possible at a relatively small increase in pressure. Only when the pressure difference is relatively high does further recess 46 tear, so that the complete predetermined breaking region 30 is released.

The modification of predetermined breaking region 30 shown in FIG. 6 is based on the variant shown in FIG. 5. Deviating from this, only recess 38 and second recess 42 are extended and designed to be bent at the ends, so that they each open into further recess 46 via an arc. Thus, after complete tearing of recess 38 or second recess 42, the tearing is started with further recess 46 via the respective intersection point with it. Thus, there is essentially a continuous tearing and release of predetermined breaking region 30.

A further variation is shown in FIG. 7, whereby the two openings 32, 34, membrane 36, and further recess 46 are also present here unchanged. Recess 38 again extends from opening 32 to further recess 46, and one of the additional recesses 40 is present, which is arranged point-symmetrically to recess 38 with respect to opening 32. The course of recess 38 and additional recess 40 is now rectilinear and perpendicular to the course of the longitudinal axis of the stadium-like predetermined breaking region 30. In other words, recess 38 and additional recess 40 open in each case into further recess 46 at a 90° angle. Second recess 42 is shaped corresponding to recess 38, and one of the additional second recesses 44 is present, which is shaped corresponding to additional recess 40. In this variant, further recess 46 tears in both directions starting from the intersection points with the other recesses 38, 40, 42, 44 after they are completely torn, so that a speed at which further recess 46 is completely torn is increased.

The variant of predetermined breaking region 30 shown in FIG. 8 essentially corresponds to the variant shown in FIG. 7. Only further recess 46 has been modified and is no longer circumferential. In other words, further recess 46 is now divided into two subsections, and predetermined breaking region 30 merges substantially continuously into the rest of wall 28 at two different locations. The two points are located along the longitudinal axis of predetermined breaking region 30 at opposite ends, whereby predetermined breaking region 30 is designed to be axially symmetrical with respect to the longitudinal axis. Due to the interrupted design of further recess 46, part of the components of predetermined breaking region 38 remain on the rest of wall 28 after complete tearing. These components of predetermined breaking region 30 are bent outwards with respect to cell housing 26 due to the pressure difference. In this way, the formation of fragments is averted, which would lead to unwanted interaction with the components surrounding battery cell 14.

FIG. 9 shows an example of predetermined breaking region 30, whereby the two openings 32, 34 and membrane 36 are present unchanged. The two openings 32, 34 are connected via connecting recess 48, which is rectilinear and runs along the longitudinal axis of the stadium-like predetermined breaking region 30. On the side opposite connecting recess 48 with respect to opening 32, recess 38, which is curved in an S-shape, opens into opening 32. The opposite end of recess 38 opens into further recess 46. Second recess 42 is designed as a mirror image of this and is also S-shaped, so that it opens into second opening 34 at the end of this opening opposite connecting recess 48. Further recess 46 has a shortened design and begins at recess 38 and second recess 42. Thus, a portion of predetermined breaking region 30 also remains on the remainder of wall 28 when all recesses 38, 42, 46, 48 are torn.

A further example of the predetermined breaking region 30 is shown in FIG. 10, whereby further recess 46 is again designed circumferential. Membrane 36 is also present unchanged. Second opening 34 is omitted, so that only opening 32 is present, which is now arranged in the center of predetermined breaking region 30. The rectilinear recess 38 and one of the rectilinear additional recesses 40 open into opening 32 on opposite sides, namely, at an angle of 180° to each other. The recess and additional recess 40 each open into further recess 46 at an angle of 120°. The production of predetermined breaking region 30 is simplified in this variant.

An example of the predetermined breaking region 30 is shown in FIG. 11, whereby further recess 46 and opening 32 are not changed compared to the example shown previously. Recess 38 and additional recess 40 are also present, which run in a straight line and are located on opposite sides with respect to opening 32. However, these are now arranged perpendicular to the course of predetermined breaking region 30 and thus intersect further recess 46 at a 90° angle. Membrane 36 is designed elongated in the longitudinal direction and covers second opening 34, which is now arranged outside predetermined breaking region 30. Mirror-symmetrically to second opening 34, a further opening 50, also covered by the elongated membrane 36, is made in wall 28 with respect to opening 32. In this illustrated variant, gas can escape via all three openings 32, 34, 50. If predetermined breaking region 30 tears, second opening 34 and further opening 50 are not affected. In the example shown, membrane 36 is designed narrower than predetermined breaking point 30. Membrane 36 can be enlarged so that it covers the entire predetermined breaking region 30. This design of membrane 36 can also be used in other preceding examples.

The variant shown in FIG. 12 corresponds substantially to the example shown in FIG. 3. Only membrane 36 is enlarged, so that it is now larger than predetermined breaking region 30. Membrane 36 also completely overlaps predetermined breaking region 30.

The invention is not restricted to the examples described above. Rather, other variants of the invention can also be derived therefrom by a person skilled in the art without departing from the subject matter of the invention. In particular, all of the individual features described in connection with the individual embodiments can also be combined with one another in other ways without departing from the subject matter of the invention.

What is claimed is:

1. A battery cell comprising:
a cell housing;
at least two electrodes arranged in the cell housing;
a wall provided on the housing, the wall having a predetermined breaking region, the predetermined breaking region comprises an opening that is covered via a gas-permeable membrane; and
a recess extending to the opening is introduced into the wall in the predetermined breaking region.

2. The battery cell according to claim 1, wherein the predetermined breaking region is limited by a further recess.

3. The battery cell according to claim 2, wherein the further recess is circumferential.

4. The battery cell according to claim 2, wherein the recess extends towards the further recess.

5. The battery cell according to claim 4, wherein an angle formed between the recess and the further recess is greater than 110°.

6. The battery cell according to claim 1, wherein an additional recess extending towards the opening is made in the wall in the predetermined breaking region.

7. The battery cell according to claim 1, wherein the predetermined breaking region comprises a second opening, and wherein a second recess extending towards the second opening is made in the wall in the predetermined breaking region.

8. The battery cell according to claim 7, wherein the first and second openings are connected via a connecting recess.

9. The battery cell according to claim 1, wherein a size of the membrane is smaller than a size of the predetermined breaking region.
